(19) United States
(12) Patent Application Publication
(10) Pub. No.: US 2007/0116001 A1
(43) Pub. Date: May 24, 2007

(54) Communication apparatus, communication system, and communication method

(76) Inventors: Shinji Kobayashi, Kawasaki (JP); Tadafusa Niinomi, Kawasaki (JP); Yuichino Ajima, Kawasaki (JP)

Correspondence Address: GREER, BURNS & CRAIN, 300 S WACKER DR, 25TH FLOOR, CHICAGO, IL, 60606, US

(21) Appl. No.: 11/647,045

(22) Filed: Dec. 27, 2006

Related U.S. Application Data
(63) Continuation of application No. PCT/JP04/12006, filed on Aug. 20, 2004.

(51) Int. Cl. H04L 12/56; H04L 12/28

(52) U.S. Cl. 370/392; 370/475

(57) ABSTRACT

A communication apparatus is connected to a transmission host that generates a header and a packet body data for generating a packet, and performs a packet communication with outside via a network. A receiving unit receives the header and the packet body data from the transmission host in a separate manner. An accumulating unit accumulates received header and packet body data. A packet generating unit generates the packet by coupling accumulated header and packet body data.

This is a continuation of International Application No. PCT/JP2004/012006, filed Aug. 20, 2004.

### BACKGROUND OF THE INVENTION

1. Field of the Invention

The present invention relates to a technology for enhancing execution efficiency in a packet communication.

2. Description of the Related Art

The current packet communication using a widespread communication protocol, such as socket application program interface (socket API) and transmission control protocol (TCP)/Internet protocol (IP), prepares an intermediate buffer, and accumulates data in the buffer, to protect the data until a process of transmitting and receiving the data is completed.

However, the process of transmitting and receiving data after accumulating the data in the buffer is quite heavy, which is becoming a bottleneck in speeding up a network, as an overflow occurs with a rapid development of a high-speed network

In a conventional technology disclosed in “Zero copy sockets and NFS patches for FreeBSD”, searched on Mar. 29th, 2004, Internet <URL: HYPERLINK http://people.freebsd.org/˜ken/zero_copy/>, a high-speed network is supported by protecting target data, by using a technology such as a copy-on-write (COW) and a page flipping, and eliminating a necessity to accumulate the data in an intermediate buffer.

Furthermore, the conventional technology executes a communication protocol process by a network adaptor to reduce a load on a host computer, which leads to an enhancement of communication efficiency to support the high-speed communication.

However, it is not necessarily the case that the conventional technology enhances execution efficiency in a packet communication.

For instance, the COW has no effect when an application immediately overwrites data in a transmission buffer, and the page flipping cannot converts an address of data for transmission and reception into an arbitrary address because the page flipping manages a memory in units of a page of a predetermined bytes. Therefore, it is extremely difficult to perform a communication process in technical terms.

On the other hand, although it is feasible to execute a communication protocol process by a network adaptor, it is hard to install a processor having an enough capability to handle a complicated communication protocol in a network card, from a standpoint of power consumption and cost.

Even when a part of the protocol process is implemented with a hardware, and when the hardware is installed in the network adaptor instead of the processor, the hardware cannot fully execute the protocol process because a communication protocol of the TCP/IP and an algorithm used in the communication protocol may be changed.

### SUMMARY OF THE INVENTION

It is an object of the present invention to at least partially solve the problems in the conventional technology.

A communication apparatus according to one aspect of the present invention is connected to a transmission host that generates a header and a packet body data for generating a packet, the communication apparatus performing a packet communication with outside via a network. The communication apparatus includes a receiving unit that receives the header and the packet body data from the transmission host in a separate manner; an accumulating unit that accumulates received header and packet body data; and a packet generating unit that generates the packet by coupling accumulated header and packet body data.

A communication system according to another aspect of the present invention includes a transmission host that generates a header and a packet body data for generating a packet; and a communication apparatus that is connected to the transmission host, and performs a packet communication with outside via a network. The transmission host includes a determining unit that determines a magnitude relation between a size of the packet body data and a predetermined size; and a transmission processing unit that transmits, when the determining unit determines that the size of the packet body data is equal to or larger than a predetermined size, the packet body data directly to the communication apparatus without copying the packet body data between memories. The communication apparatus includes a receiving unit that receives the header and the packet body data from the transmission host in a separate manner; an accumulating unit that accumulates received header and packet body data; and a packet generating unit that generates the packet by coupling accumulated header and packet body data.

A communication method of performing a packet communication with outside via a network, according to still another aspect of the present invention, includes receiving a header and a packet body data that constitute a packet; in a separate manner; accumulating received header and packet, body data in a storage unit; and generating the packet by coupling accumulated header and packet body data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a communication system according to an embodiment of the present invention;

FIG. 2 is a schematic diagram for explaining an example of a data structure of a DMA descriptor;

FIG. 3 is a flowchart of a pre-transmission process performed by a transmission host;

FIG. 4 is a flowchart of a transmission process performed by the transmission host;

FIG. 5 is a flowchart of a packet generating process performed by a packet-generation processing unit; and

FIG. 6 is a flowchart of a header separating process performed by a header-separation processing unit.

### DETAILED DESCRIPTION OF THE PREFERRED EMBODIMENTS

Exemplary embodiments according to the present invention will be explained in detail below with reference to the accompanying drawings.

A transmission host according to an embodiment of the present invention transmits a packet body data directly to a network adaptor, without performing a copy of the packet body data between memories, and the network adaptor accumulates received packet body data in a buffer.

After that, the transmission host transmits a header to the network adaptor. The network adaptor generates a packet by coupling the packet body data accumulated in the buffer and the header, and transmit generated packet to a destination via a network interface (I/F) unit, to enhance a communication performance.

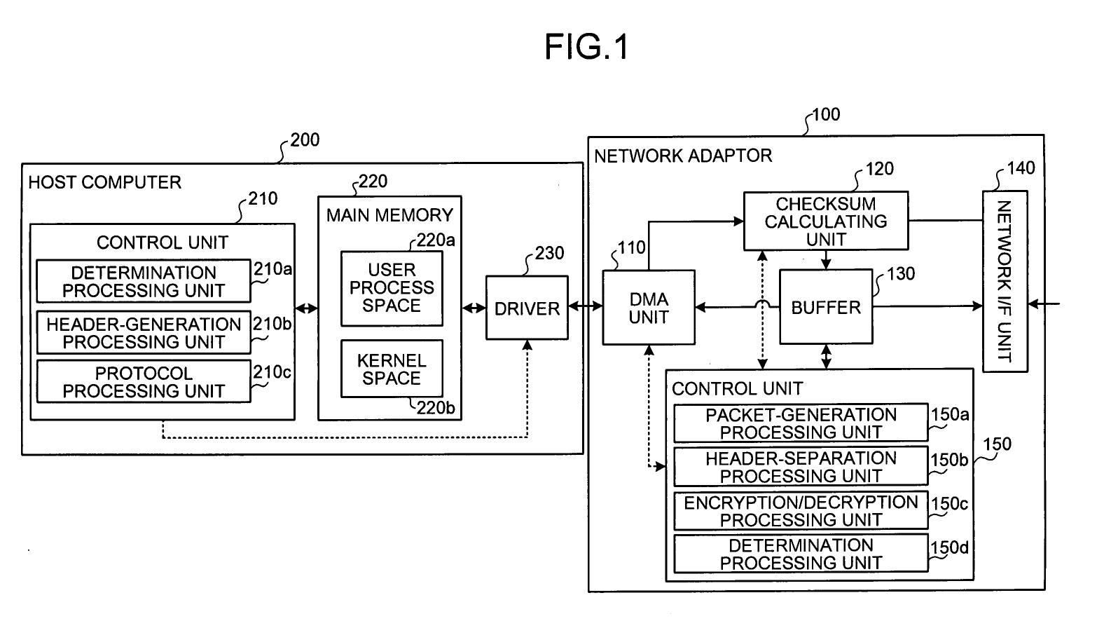

FIG. 1 is a functional block diagram of a communication system according to the present embodiment. The communication system includes a network adaptor 100 and a host computer 200. The network adaptor 100 and the host computer 200 are connected together by a bus.

The network adaptor 100 generates a packet from a packet body data transmitted from the transmission host and a header, and transmits generated packet to a destination that is specified by the header. The packet body data indicates data constituting the packet other than the header.

In addition, when a packet is received, the network adaptor 100 separates a header and a packet body data from received packet, and transmits the header and the packet body data to the host computer 200 in a separate manner. Although a single network adaptor 100 is shown in FIG. 1 for the sake of convenience in explanation, an arbitrary number of network adaptors can be connected to the communication system.

The host computer 200 receives a transmission request from a user application, and transmits the packet body data to the network adaptor 100 without copying the data between memories. In addition, the host computer 200 generates a header, and transmits generated header to the network adaptor 100.

The network adaptor 100 includes a direct memory access (DMA) unit 110, a checksum calculating unit 120, a buffer 130, a network I/F unit 140, and a control unit 150.

The DMA unit 110 receives the packet body data and the header from the transmission host, and passes received data to the checksum calculating unit 120. In addition, the DMA unit 110 transmits data accumulated in the buffer 130 to the host computer 200, according to an instruction from the control unit 150.

The checksum calculating unit 120 receives data from the DMA unit 110 or the network I/F unit 140, performs a checksum calculation on received data, and notifies a result of the checksum calculation to the control unit 150. Information required for executing a checksum is transmitted from the control unit 150. In addition, the checksum calculating unit 120 accumulates a checksum-calculation-executed data in the buffer 130.

The buffer 130 accumulates therein data received from the checksum calculating unit 120. The network I/F unit 140 is a network card for connecting with an external network, which transmits data received from the buffer 130 to a destination that is specified by the header. In addition, the network I/F unit 140 passes a packet received from outside to the checksum calculating unit 120.

The control unit 150 includes a packet-generation processing unit 150a, a header-separation processing unit 150b, an encryption/decryption processing unit 150c, and a determination processing unit 150d.

The packet-generation processing unit 150a generates a packet by coupling the packet body data and the header accumulated in the buffer 130, and passes generated packet to the network I/F unit 140. The packet-generation processing unit 150a generates the packet based on a DMA descriptor transmitted from the host computer 200.

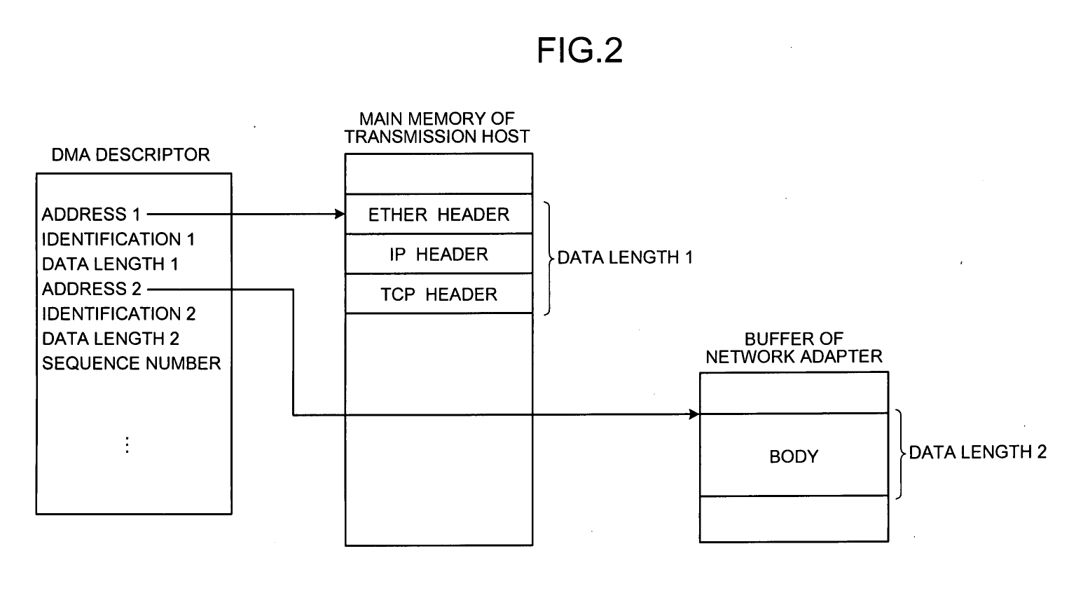

FIG. 2 is a schematic diagram for explaining an example of a data structure of the DMA descriptor. As shown in the figure, the DMA descriptor includes an address, an identification flag, a data length, and a sequence number. The address is information for specifying a location of the header or the packet body data. The identification flag is information indicating whether corresponding data is stored in a main memory of the host computer 200 or in the buffer 130 of the network adaptor 100.

For instance, when the identification flag is “identification 1”, it means that the corresponding data is stored in the main memory of the host computer 200. On the other hand, when the identification flag is “identification 2”, it means that the corresponding data is stored in the buffer 130 of the network adaptor 100. The data length indicates a size of the corresponding data.

The sequence number is information for determining whether all of the packet body data in the host computer 200 is transmitted to the network adaptor 100.

In other words, the packet-generation processing unit 150a determines whether all of the packet body data is accumulated in the buffer 130 based on the sequence number included in the DMA descriptor, and after that, transmits the packet to the network I/F unit 140.

The header-separation processing unit 150b analyzes a packet received from the outside, and separates a header and a packet body data from the packet. In addition, the header-separation processing unit 150b sends a command to the DMA unit 110 to transmit addresses of separated header and packet body data to the host computer 200. The addresses of the header and the packet body data are accumulated in a kernel space 220b of the host computer 200.

The encryption/decryption processing unit 150c performs an encryption of a packet when encrypting the packet generated by the packet-generation processing unit 150a. Furthermore, the encryption/decryption processing unit 150c performs a decryption of an encrypted packet when the packet received from the outside is encrypted.

The determination processing unit 150d determines whether to perform an ordinary process or a process according to the present invention on a packet, based on a size of the packet. When the size of the packet is smaller than a predetermined size, the determination processing unit 150d sends a command to the header-separation processing unit 150b to transmit the packet as it is to the host computer 200, without performing a separation of the header and the packet body data from the packet.

On the other hand, when the size of the packet is equal to or larger than the predetermined size, the determination processing unit 150d sends a command to the header-separation processing unit 150b to perform the process according to the present invention. In this manner, the determination processing unit 150d can prevent a degradation of performance with a small-size packet, by switching an operation of the header-separation processing unit 150b.

The host computer 200 includes a control unit 210, a main memory 220, and a driver 230. The control unit 210 includes a determination processing unit 210a, a header-generation processing unit 210b, and a protocol processing unit 210c.

The determination processing unit 210a receives a transmission request from a user application (not shown), and determines whether to perform the ordinary process or the process according to the present invention, based on a condition such as the size of the packet. When the size of the packet is smaller than the predetermined size, the determination processing unit 210a determines to perform the ordinary process.

When it is determined to perform the ordinary process, the determination processing unit 210a copies the packet body data recorded in a user process space 220a of the host computer 200 to the kernel space 220b. After that, the determination processing unit 210a transmits the packet body data to the network adaptor 100 together with a header that is generated by the header-generation processing unit 210b.

On the other hand, when the size of the packet is equal to or larger than the predetermined size, the determination processing unit 210a determines to perform the process according to the present invention. In this case, the packet body data recorded in the user process space 220a is directly transmitted to the network adaptor 100 by the driver 230, without being copied to the kernel space 220b.

In this case, the determination processing unit 210a locks the packet body data recorded in the user process space 220a in the main memory 220 until all of the packet body data is transmitted to the network adaptor 100, to prevent the packet body data from being paged out to a hard disk (not shown).

In this manner, by transmitting the packet body data recorded in the user process space 220a directly to the network adaptor 100, the necessity to copy the packet body data between the user process space 220a and the kernel space 220b can be eliminated. As a result, it is possible to reduce a communication load on the main memory 220.

The header-generation processing unit 210b generates a header and a DMA descriptor in the kernel space 220b, and transmits generated header and DMA descriptor to the network adaptor 100 via the driver 230.

The protocol processing unit 210c receives a result of the checksum calculation for a packet received from the outside by the network adaptor 100, a header, and an address of a packet body data accumulated in the network adaptor 100, via the driver 230.

Then, the protocol processing unit 210c performs a protocol process based on the header, and determines a final destination of the packet. After that, the protocol processing unit 210c transmits the packet body data from the network adaptor 100 to the user process space 220a via the driver 230, based on the address of the packet body data, after performing a setting to make a target user process space 220a not be paged out.

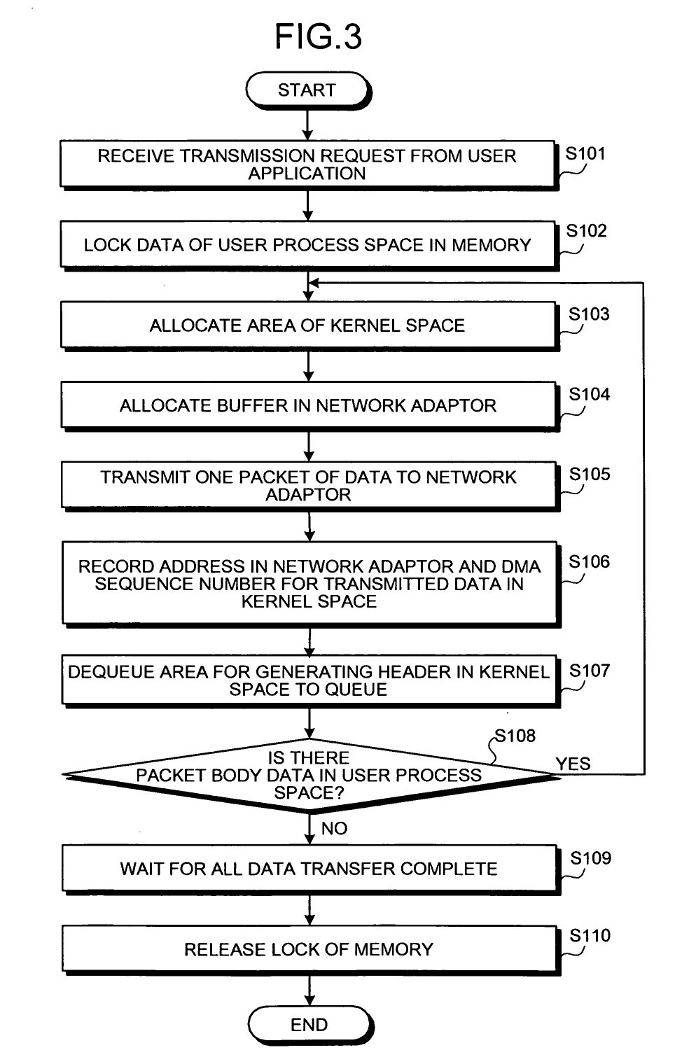

FIG. 3 is a flowchart of a pre-transmission process performed by the host computer 200. In the example shown in FIG. 3, a process performed when the determination processing unit 210a determined to perform the process according to the present invention is explained, and an explanation on the ordinary process is omitted.

As shown in the figure, the determination processing unit 210a receives a transmission request from a user application (step S101), locks data recorded in the user process space 220a in the main memory 220 (step S102). The header-generation processing unit 210b allocates an area in the kernel space 220b (step S103).

The host computer 200 allocates the buffer 130 in the network adaptor 100 (step S104), transmits one packet of data to the network adaptor 100 (step S105), and records an address in the network adaptor 100 and a DMA sequence number for transmitted data in the kernel space 220b (step S106).

The header-generation processing unit 210b enqueues an area for generating a header in the kernel space 220b to a queue (step S107), and the determination processing unit 210a determines whether the packet body data is present in the user process space 220a (step S108).

When the packet body data is present in the user process space 220a (Yes at step S108), the process is moved to step S103, and when the packet body data is not present in the user process space 220a (No at step S108), the process waits until all of the data transfers is completed (step S109). When all of the data transfers is completed, the determination processing unit 210a releases the lock of the user process space 220a (step S110).

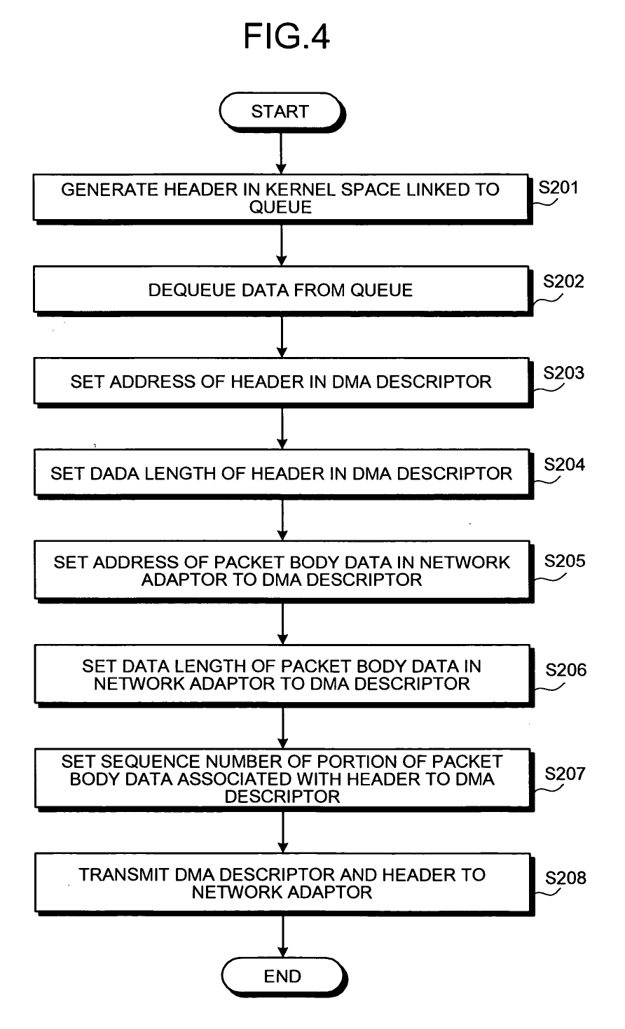

FIG. 4 is a flowchart of a transmission process performed by the host computer 200. As shown in the figure, the header-generation processing unit 210b generates a header in the kernel space 220b that is linked to the queue (step S201), and dequeues the header from the queue (step S202).

After that, the header-generation processing unit 210b sets an address of the header to the DMA descriptor (step S203), and sets a data length of the header to the DMA descriptor (step S204).

Then, the header-generation processing unit 210b sets an address of the packet body data in the network adaptor 100 to the DMA descriptor (step S205), and sets a data length of the packet body data in the network adaptor 100 to the DMA descriptor (step S206).

Finally, the header-generation processing unit 210b sets a sequence number of the portion of the packet body data associated with header to the DMA descriptor (step S207), and transmits the DMA descriptor and the header to the network adaptor 100 (step S208).

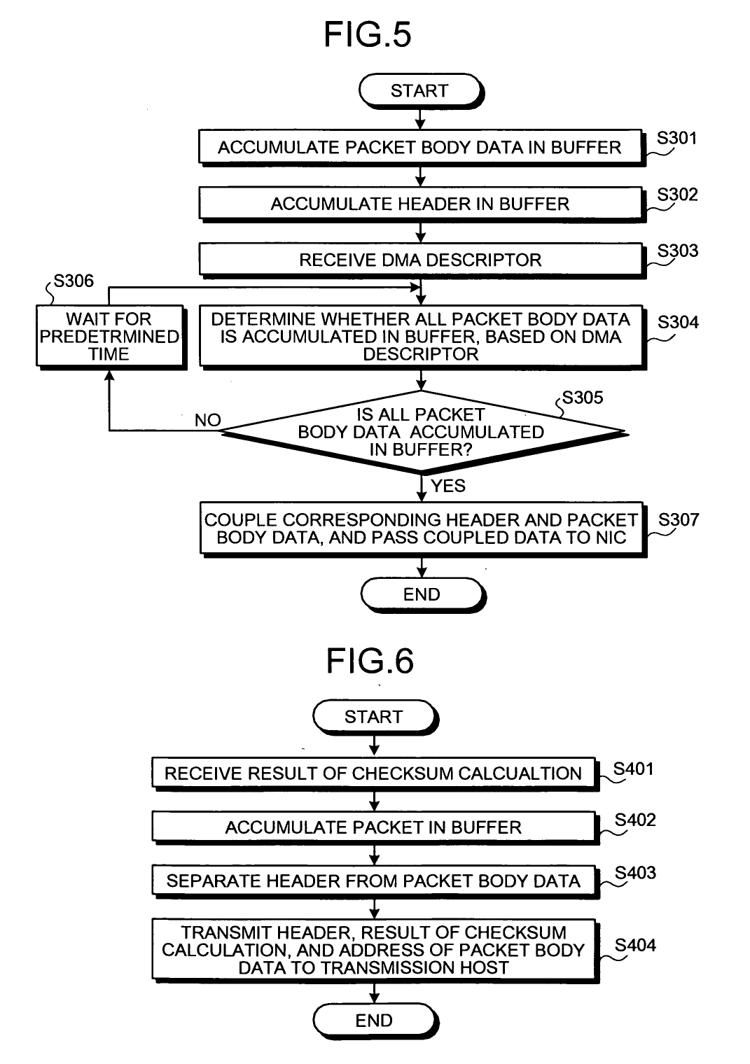

FIG. 5 is a flowchart of a packet generating process performed by the packet-generation processing unit 150a. As shown in the figure, the packet body data is accumulated in the buffer 130 (step S301), and the header is accumulated in the buffer 130 (step S302).

The packet-generation processing unit 150a receives the DMA descriptor (step S303), and determines whether all of the packet body data is accumulated in the buffer 130, based on the DMA descriptor (step S304).

When all of the packet body data is not accumulated in the buffer 130 (No at step S305), after waiting for a predetermined time (step S306), the process is moved to step S304. On the other hand, when all of the packet body data is accumulated in the buffer 130 (Yes at step S305), the packet-generation processing unit 150a couples corresponding header and packet body data, and transmits coupled header and packet body data to the network I/F unit 140 (step S307).

FIG. 6 is a flowchart of a header separating process performed by the header-separation processing unit 150b. As shown in the figure, the header-separation processing unit 150b receives a result of the checksum calculation from the checksum calculating unit 120 (step S401), and accumulates a packet from the outside in the buffer 130 (step S402).

The header-separation processing unit 150b separates a header and a packet body data from the packet (step S403), and transmits the header, the result of the checksum calculation, and an address of the packet body data to the host computer 200 (step S404).

As describe above, according to the present embodiment, the determination processing unit 210a transmits the packet body data accumulated in the user process space 220a directly to the network adaptor 100 via the driver 230, without copying the packet body data to the kernel space 220b. The header-generation processing unit 210b generates the header and the DMA descriptor, and transmits generated header and DMA descriptor to the network adaptor 100 via the driver 230. The packet-generation processing unit 150a generates a packet based on the DMA descriptor, the header, and the packet body data, and transmits generated packet to a destination via the network I/F unit 140. Therefore, a waste of resources such as a memory bus can be reduced, and as a result, it is possible to enhance the execution efficiency in a data communication of the communication system.

According to an embodiment of the present invention, a header and a packet body data are separately received from a transmission host, received header and packet body data are accumulated, and a packet is generated by coupling accumulated header and packet body data. Therefore, it is possible to enhance the execution efficiency in a packet communication.

Furthermore, according to an embodiment of the present invention, when a packet is received from outside, a header and a packet body data are separated from the packet, separated header and packet body data are accumulated, and location specifying information for specifying locations of the header and the packet body data is transmitted to a transmission host. Therefore, a load on the transmission host can be reduced, supporting a high-speed network.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication apparatus that is connected to a transmission host that generates a header and a packet body data for generating a packet, the communication apparatus performing a packet communication with outside via a network, the communication apparatus comprising:
a receiving unit that receives the header and the packet body data from the transmission host in a separate manner;
an accumulating unit that accumulates received header and packet body data; and
a packet generating unit that generates the packet by coupling accumulated header and packet body data.

2. The communication apparatus according to claim 1, further comprising:
a separation processing unit that separates, when a packet is received from outside, a header and a packet body data from received packet, accumulates separated header and packet body in the accumulating unit, and transmits the header and location specifying information for specifying a location of the packet body data to the transmission host.

3. The communication apparatus according to claim 2, further comprising:
a determining unit that determines, when the packet is received from the outside, a magnitude relation between a size of the packet and a predetermined size, wherein
when the determining unit determines that the size of the packet is equal to or larger than the predetermined size, the separation processing that separates the header and the packet body data from received packet, accumulates the separated header and packet body in the accumulating unit, and transmits the header and the location specifying information to the transmission host.

4. A communication system comprising:
a transmission host that generates a header and a packet body data for generating a packet; and
a communication apparatus that is connected to the transmission host, and performs a packet communication with outside via a network, wherein
the transmission host includes
a determining unit that determines a magnitude relation between a size of the packet body data and a predetermined size; and
a transmission processing unit that transmits, when the determining unit determines that the size of the packet body data is equal to or larger than a predetermined size, the packet body data directly to the communication apparatus without copying the packet body data between memories, and
the communication apparatus includes
a receiving unit that receives the header and the packet body data from the transmission host in a separate manner;
an accumulating unit that accumulates received header and packet body data; and
a packet generating unit that generates the packet by coupling accumulated header and packet body data.

5. A communication method of performing a packet communication with outside via a network, the communication method comprising:
receiving a header and a packet body data that constitute a packet, in a separate manner;
accumulating received header and packet body data in a storage unit; and
generating the packet by coupling accumulated header and packet body data.
